(19) United States
(12) Patent Application Publication
(10) Pub. No.: US 2021/0328344 A1
(43) Pub. Date: Oct. 21, 2021

(54) Method and System for Controlling a Null Steering Antenna Having a Variable Reactance Active Element

(71) Applicant: AVX Antenna, Inc. d/b/a Ethertronics, Inc., San Diego, CA (US)

(72) Inventor: John Eric Shamblin, San Diego, CA (US)

(21) Appl. No.: 17/232,530

(22) Filed: Apr. 16, 2021

Related U.S. Application Data
(60) Provisional application No. 63/012,422, filed on Apr. 20, 2020.

(51) Int. Cl. H01Q 3/26; H01Q 25/00; H04B 17/309

(52) U.S. Cl. CPC H01Q 3/2629; H04B 17/309; H01Q 25/00

(57) ABSTRACT

A method for tuning an antenna system having a parasitic element coupled to a variable reactance element is provided. The method can include determining a plurality of reactance values in a span of reactance values for which a variable reactance element is configurable. The parasitic element can be configured to implement an operation mode of a null steering antenna in a selected mode defined by a selected reactance value within the span of reactance values. The method can include sampling a plurality of sampled channel quality indicators at each of the plurality of reactance values. The method can include determining a subset of the span of reactance values, the subset of the span including a reactance value having an increased sampled channel quality indicator. The method can include selecting one of the subset of the plurality of reactance values to tune the null steering antenna in the selected mode.

### PRIORITY CLAIM

The present application claims the benefit of priority of U.S. Provisional App. No. 63/012,422, titled “Method and System for Controlling a Null Steering Antenna Having a Variable Reactance Active Element,” having a filing date of Apr. 20, 2020, which is incorporated by reference herein.

### FIELD

Example aspects of the present disclosure relate generally to the field of antenna control, for instance, the control of null steering antennas configured to operate in a plurality of different modes.

### BACKGROUND

Null steering antennas are being increasingly used in wireless communication, for instance in smartphone handsets. Such antennas generally provide improved signal quality for a given form factor compared to traditional passive antennas. One null steering antenna configuration involves a parasitic element configured to alter a radiation pattern associated with a radiating element.

### SUMMARY

Aspects and advantages of embodiments of the present disclosure will be set forth in part in the following description, or can be learned from the description, or can be learned through practice of the embodiments.

One example aspect of the present disclosure is directed to an antenna system. The antenna system can include a null steering antenna including a radiating element and a parasitic element. The null steering antenna can be operable in a selected mode of a plurality of modes, where each mode of the plurality of modes can be associated with a different radiation pattern. The antenna system can include a variable reactance element coupled to the parasitic element, the variable reactance element configured to vary a reactance at the parasitic element to select the selected mode. The antenna system can include a controller configured to vary the reactance to tune the null steering antenna in the selected mode of the plurality of modes. The controller can be configured to vary the reactance by performing a binary search process to select a reactance based at least in part on a channel quality indicator associated with the null steering antenna in the selected mode.

Another example aspect of the present disclosure is directed to a method for tuning an antenna system including a parasitic element coupled to a variable reactance element. The method can include determining, by a controller, a plurality of reactance values in a span of reactance values for which a variable reactance element is configurable. The parasitic element can be configured to implement an operation mode of a null steering antenna in a selected mode defined by a selected reactance value within the span of reactance values. The method can include sampling, by the controller, a plurality of sampled channel quality indicators at each of the plurality of reactance values. The method can include determining, by the controller, a subset of the span of reactance values, the subset of the span including a reactance value having an increased sampled channel quality indicator. The method can include selecting one of the subset of the plurality of reactance values to tune the null steering antenna in the selected mode.

Yet another example aspect of the present disclosure is directed to an antenna system. The antenna system can include a null steering antenna. The null steering antenna can include a radiating element and a parasitic element. The null steering antenna can operate in a selected mode of a plurality of modes. Each of the plurality of modes can be associated with a different radiation pattern. The antenna system can include a varactor diode coupled to the parasitic element. The varactor diode can be configured to vary a reactance at the parasitic element to select the selected mode. The antenna system can include a controller configured to vary the reactance of the varactor diode to tune the null steering antenna to the selected mode of the plurality of modes.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1A illustrates an embodiment of a null steering antenna according to example embodiments of the present disclosure;

FIG. 1B illustrates a two-dimensional antenna radiation pattern associated with the null steering antenna of FIG. 1A;

FIG. 1C illustrates an example frequency plot of the null steering antenna of FIG. 1A according to example embodiments of the present disclosure;

FIG. 2 illustrates a schematic diagram of an example antenna system according to example embodiments of the present disclosure;

FIG. 3 illustrates a schematic diagram of an example antenna system including a variable active steering element according to example embodiments of the present disclosure;

FIG. 4 illustrates an example tuning process according to example embodiments of the present disclosure; and

FIG. 5 depicts a flow diagram of an example method according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to an antenna system. The antenna system can include a null steering antenna including a radiating element and a parasitic element positioned proximate to the radiating element. Although example aspects of the present disclosure are discussed with reference to a null steering antenna, the example aspects discussed herein can be applicable to any suitable antenna system, such as, for example, a beam steering antenna, a modal antenna, etc.

The null steering antenna can be operable in a plurality of different modes. Each mode can be associated with a different radiation pattern and/or polarization state. For instance, electrical characteristics associated with the parasitic element can be controlled to adjust operating characteristics of the antenna system. As one example, the antenna system can include a controller that is configured to control electrical characteristics associated with the parasitic element to operate the null steering antenna in the plurality of different modes. For instance, the controller can configure the null steering antenna in a mode that provides a suitable communication quality (e.g., signal strength, noise ratio, etc.) with target(s) of the null steering antenna. As one example, the controller can control the beam direction and/or null direction of a radiation pattern, referred to as “beam steering” and/or “null steering.”

In some systems, the null steering antenna can be tuned by selecting one of a plurality of reactive elements coupled to the parasitic element. For example, the controller may select between two to about four capacitors and/or inductors to be coupled to the parasitic element. The tuning circuit may sample each of the reactive elements and determine which of the capacitors and/or inductors provides a suitable (e.g., optimized, maximized, satisfying a threshold, etc.) communication quality. While this solution can effectively tune a null steering antenna, improvements to null steering antenna control, including granularity of operating characteristic control, such as improved granularity of beam steering and/or null steering capabilities, can be desirable. As another example, it can be desirable to maintain a shape or form of a radiation pattern as the radiation pattern is steered.

According to example aspects of the present disclosure, an antenna system can include a radiating element and a parasitic element positioned proximate to the radiating element. A variable reactance element can be coupled to the parasitic element. The variable reactance element can be configured to adjust operating characteristics of the antenna system. In particular embodiments, the variable reactance element can be a varicap or a varactor diode. The variable reactance element can provide a variable reactance such that the operating characteristics of the antenna system can vary with the reactance of the variable reactance element. In some embodiments, the variable reactance element can be a continuously variable reactance element. A continuously variable reactance element can be variable (e.g., continuously variable) over a span of possible reactance values (e.g., from a minimum reactance value to a maximum reactance value) without breaks or jumps in the span. For instance, the continuously variable reactance element can be tuned to any reactance value in the span with infinite precision and/or with some consistent or otherwise predictable precision throughout.

The variable reactance element can provide for improved granularity with respect to control of a radiation pattern of the null steering antenna. As one example, the reactance of the variable reactance element can vary (e.g., incrementally and/or continuously) such that a radiation pattern formed by the antenna system rotates as the reactance is varied. As another example, the variable reactance element can provide a reactance that can be varied (e.g., incrementally) over a span (e.g., from a minimum to a maximum). In some cases, this can provide for greater control characteristics compared to, for example, switching between a plurality of discrete active elements (e.g., fixed inductors and/or capacitors) configured to provide different electrical characteristics, variable resistance elements (e.g., varistors), and/or some other systems.

Incorporating a variable reactance element can provide for improvements to null steering antenna systems, as discussed above. However, incorporating a variable reactance element can introduce additional challenges. For instance, some tuning methods may not be easily applicable to a variable reactance element and/or may not achieve an optimal tuning. As one example, whereas an antenna system having a plurality of reactive elements coupled to a parasitic element can tune the antenna by simply sampling the connection with each of the plurality of reactive elements, an antenna system having a variable reactance element can require tuning the variable reactance by selecting from a very large span of possible reactance values, which can require more computing time, computing resources, etc.

According to example aspects of the present disclosure, an antenna system can perform a binary search process to tune the variable reactance element and/or a null steering antenna. For instance, a controller can sample channel quality according to a suitable channel quality indicator (e.g., RSSI, SINR) at a plurality of reactance values (e.g., a highest possible reactance, a lowest possible reactance, and a middle reactance between the highest possible reactance and the lowest possible reactance). The controller can determine a subset of the sampled plurality of reactance values that bounds a reactance value providing an optimal (e.g., maximum or near maximum) channel quality. This process can be repeated iteratively, with each iteration limiting the span over which the plurality of reactance values is sampled to the determined subset. This process can be repeated until the process is completed (e.g., if the span is sufficiently small and/or the channel quality is sufficiently high), over a predetermined number of iterations, etc. In some embodiments, the controller can iteratively sample over the span with some resolution once the binary search process is completed to tune the reactance value precisely while having reduced contribution to computing time and/or computing resources required to tune the reactance resulting from the reduced span of the binary search process.

As used herein, “near maximum” can refer to within 20% of a maximum and including the maximum. Similarly, “near minimum” can refer to within 20% of a minimum and including the minimum. “Optimal” can refer to one or both of near maximum and/or near minimum, dependent upon whether a maximum or minimum value is desirable, respectively. For example, an “optimal” channel quality indicator where a greater value is associated with better channel quality can have a near maximum optimum.

The systems and methods according to example embodiments of the present disclosure provide a number of technical effects and benefits. For instance, the systems and methods according to example embodiments of the present disclosure can provide for improved control of a null steering antenna. For example, incorporating a variable reactance element to tune a parasitic element can allow for the null steering antenna to adjust a radiation pattern with improved granularity, which can enable selection of a mode that is more optimal (e.g., with improved granularity). As one example, incorporating a varactor diode or varicap as and/or within the active element can provide for improved ease of control of a null steering antenna system.). For instance, the varactor diode can be controlled using simple control circuits, which can offer a reduction in production costs, footprint, cost of operation, etc. As another example, systems and methods according to the present disclosure can provide for improved methods of tuning a null steering antenna having a variable reactance element coupled to a parasitic element. For instance, systems and methods according to the present disclosure can incorporate a binary search process to tune the variable reactance element and/or the null steering antenna to reduce an amount of sampling, computation time, etc. required to arrive at a sufficient (e.g., optimal) tuning while achieving the improved tuning associated with the use of the variable reactance element (e.g., a varicap). Furthermore, the binary search process can prevent excess computation time allocated to sampling reactance values with greatly suboptimal channel quality.

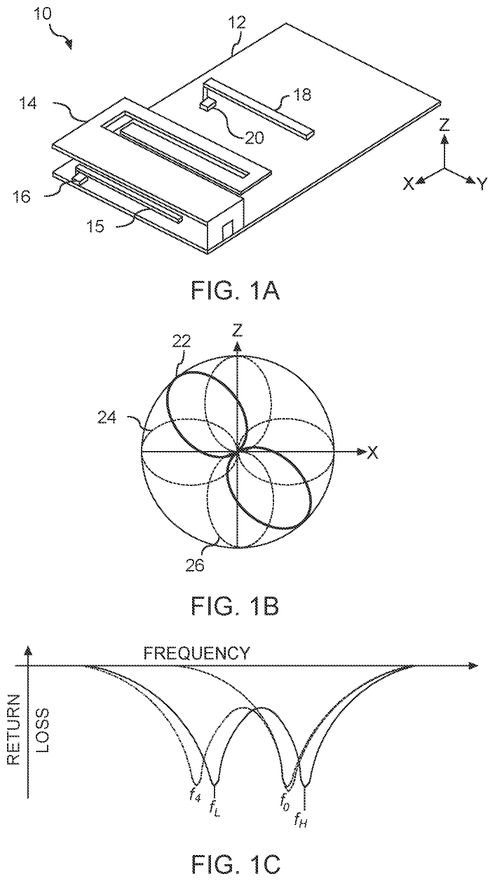

With reference now to the Figures, example aspects of the present disclosure are discussed. FIG. 1A illustrates an example embodiment of a null steering antenna 10 in accordance with aspects of the present disclosure. The null steering antenna 10 can include a circuit board 12 (e.g., including a ground plane) and a radiating element 14 disposed on the circuit board 12. In some embodiments, the radiating element can be an isolated magnetic dipole radiating element. An antenna volume can be defined between the circuit board (e.g., and the ground plane) and the radiating antenna element. A first parasitic element 15 can be positioned at least partially within the antenna volume. A first active tuning element 16 can be coupled with the parasitic element 15. The first active tuning element 16 can be a passive or active component or series of components and can be configured to alter a reactance on the first parasitic element 15 (e.g., by way of a variable reactance element, shorting to ground, etc.) resulting in a frequency shift of the antenna. In some embodiments, the first parasitic element 15 and/or the first active tuning element 16 can be omitted.

In some embodiments, a second parasitic element 18 can be disposed proximate the circuit board 12 and can be positioned outside of the antenna volume. The second parasitic element 18 can further include a second active tuning element 20 which can individually include one or more active and/or passive components configured to alter a reactance on the second parasitic element 18 (e.g., by way of a variable reactance element, shorting to ground, etc.) resulting in a frequency shift of the antenna. The second parasitic element 18 can be positioned adjacent the radiating element 14 and can also be positioned outside of the antenna volume. In some embodiments, the second parasitic element 18 and/or the second active tuning element 20 can be omitted.

The described configuration can provide an ability to shift the radiation pattern characteristics of the radiating antenna element by varying a reactance thereon. Shifting the antenna radiation pattern can be referred to as “beam steering”. In instances where the antenna radiation pattern comprises a null, a similar operation can be referred to as “null steering” since the null can be shifted to an alternative position about the antenna (e.g., to reduce interference). In some embodiments, the second active tuning element 20 can include a switch for connecting the second parasitic to ground when “On” and for terminating the short when “Off”. It should however be noted that a variable reactance on either of the first or second parasitic elements, for example by using a variable capacitor or other tunable component, can further provide a variable shifting of the antenna pattern or the frequency response. For example, the first active tuning element 16 and/or second active tuning element 18 can include at least one of a varicap or varactor diode, tunable inductor, or switch.

FIG. 1B illustrates a two-dimensional antenna radiation pattern associated with the null steering antenna of FIG. 1A. The radiation pattern can be shifted by controlling an electrical characteristic associated with at least one of the first and second parasitic elements 16, 18 of the null steering antenna 10. For example, in some embodiments, the radiation pattern can be shifted from a first mode 22 to a second mode 24, or a third mode 26.

FIG. 1C illustrates an example frequency plot of the null steering antenna of FIG. 1A according to some aspects of the present disclosure. The frequency of the antenna can be shifted by controlling an electrical characteristic associated with at least one of the first or second parasitic elements 16, 18 of the null steering antenna 10. For example, a first frequency (f₀) of the antenna can be achieved when one or both of the first and second parasitic elements are tuned by a first reactance value; the frequencies (f_{L}) and (f_{H}) can be produced when the second parasitic is shorted to ground; and the frequencies (f₄; f₀) can be produced when the first and second parasitic elements are each shorted to ground (e.g., have zero reactance). It should be understood that other configurations are possible within the scope of this disclosure. For example, more or fewer parasitic elements can be employed. The positioning and/or variable tuning of the parasitic elements can be altered to achieve additional modes that can exhibit different frequencies and/or combinations of frequencies.

FIGS. 1A-1C depict one example null steering antenna having a plurality of modes for purposes of illustration and discussion. Those of ordinary skill in the art, using the disclosures provided herein, will understand that other null steering antennas and/or antenna configurations can be used without deviating from the scope of the present disclosure. As used herein a “null steering antenna” refers to an antenna capable of operating in a plurality of modes where each mode is associated with a distinct radiation pattern.

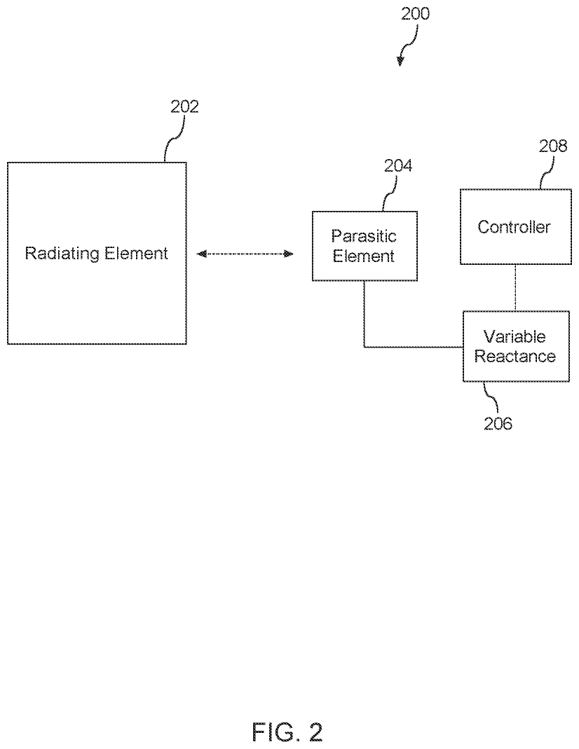

FIG. 2 illustrates a schematic diagram of an example antenna system 200 according to example embodiments of the present disclosure. The antenna system 200 can include radiating element 202. Radiating element 202 can be energized such that the radiating element 202 radiates an electric field. For instance, the radiating element 202 can be energized with a transmit signal to produce an electric field suitable to wirelessly transmit data. Additionally and/or alternatively, an electric field incident on radiating element 202 can induce a receive signal in radiating element 202.

The antenna system 200 can further include parasitic element 204. Parasitic element 204 can be coupled to radiating element 202 such that parasitic element 204 interacts with an electric field produced by radiating element 202 to form a radiation pattern. For instance, radiating element 202 and parasitic element 204 can collectively define a portion of a null steering antenna. As an example, the parasitic element 204 can be tuned to adjust an electrical characteristic (e.g., reactance) of the parasitic element 204, which can affect the interaction of parasitic element 204 with electric fields from the radiating element 202. In this way, the null steering antenna can operate in a plurality of modes, wherein each of the plurality of modes is characterized by a radiation pattern formed by interactions between the radiating element 202 and the parasitic element 204. The parasitic element 204 can be tuned (e.g., by controller 208) to select a selected mode from the plurality of modes such that the null steering antenna operates in the selected. In some embodiments, more than one parasitic element 204 can be included in the null steering antenna, in which case the selected mode can be defined by tunings of each parasitic element 204. Only one parasitic element 204 is illustrated for the purposes of discussion.

According to example aspects of the present disclosure, a variable reactance element 206 (e.g., a continuously variable reactance element) can be coupled to the parasitic element 204. For instance, the variable reactance element 206 can be an active element, as discussed above with reference to FIGS. 1A-1C. The variable reactance element 206 can be configured to vary a reactance at the parasitic element 204. For instance, the variable reactance element 206 can provide a variable reactance that is seen by the parasitic element 204 to adjust an operating mode of the null steering antenna (e.g., select a selected mode from a plurality of modes). As one example, controller 208 can vary the reactance provided by the variable reactance element 206. In some embodiments, the variable reactance element 206 can be or can include a varactor diode.

Providing a variable reactance element 206 (e.g., a varactor diode) can allow for improved control of the antenna system 200. For instance, including the variable reactance element (e.g., varactor diode) can allow for fine adjustment of the operating mode of the null steering antenna. As one example, the plurality of modes can define a continuous range of modes respective to a range or span of reactance values of the variable reactance element 206 (e.g., a continuous variable reactance element). To achieve desirable signal channels (e.g., having a high channel quality), the controller 208 can tune the parasitic element 204 by altering the reactance of variable reactance element 206.

The controller 208 can perform or implement a binary search process to select the reactance. The binary search process can be based at least in part on a channel quality indicator (CQI). The channel quality indicator can be or can include any suitable channel quality indicator and/or combination thereof. For example, the channel quality indicator can include bit error rate (BER), signal-to-interference-plus-noise ratio (SINR), received signal strength indicator (RSSI), or any other suitable channel quality indicator.

In some embodiments, the binary search process can include determining (e.g., by the controller 208) a plurality of reactance values in a span of reactance values for which the variable reactance element 206 is configurable. For example, the variable reactance element 206 can define a span, such as a continuous span, of reactance values that the variable reactance element 206 is capable of being configured to provide. In some embodiments, for example, the span of reactance values may be dependent on a span of voltage and/or current values that can be provided to and/or across the variable reactance element. As one example, the plurality of reactance values may include a low reactance value, such as a minimum reactance value of the span of reactance values, and a high reactance value, such as a near maximum reactance value of the span of reactance values. Additionally and/or alternatively, the plurality of reactance values can include a medium reactance value between the minimum reactance value and the near maximum reactance value, such as a middle reactance value that is halfway between the minimum reactance value and the near maximum reactance value.

Additionally and/or alternatively, the binary search process can include sampling (e.g., by the controller 208) a plurality of sampled channel quality indicators at each of the plurality of reactance values. For instance, the controller 208 can obtain the sampled channel quality indicators at a selected set of the span of reactance values. As one example, the controller 208 can sample a low reactance value (e.g., a minimum defined by the span of reactance values), a high reactance value (e.g., a near maximum defined by the span of reactance value), and a middle reactance value splitting the low reactance value and the high reactance value.

Additionally and/or alternatively, the binary search process can include determining (e.g., by the controller 208) a subset of the span of reactance values. For instance, the subset of the span can include a reactance value having a near maximum sampled channel quality indicator. As an example, the samples can generally be indicative of a reactance that provides optimal channel quality (e.g., a near maximum channel quality). For example, the samples can bound a reactance value that provides an optimal channel quality. Generally, two of the reactance values having the highest sampled channel quality indicator can bound the optimal channel quality reactance value.

In some embodiments, determining the subset of the span of reactance values can include determining (e.g., by the controller 208) a first reactance value associated with a highest sampled channel quality indicator and a second reactance value associated with a next highest sampled channel quality indicator. The subset of the span can thus be between the first reactance value and the second reactance value. As one example, if the sampled channel quality indicators correspond to a low reactance value, a medium reactance value, and a high reactance value, the two of the three sampled reactance values with the highest channel quality indicators can bound the optimal reactance value. For instance, one of the two bounding reactance values can have a highest sampled channel quality indicator and the other of the two bounding reactance values can have a next highest sampled channel quality indicator. The next highest sampled channel quality can be equivalent to the highest sampled channel quality indicator, in some cases. Thus, the subset of the span of reactance values can be determined to be between one of the low and medium reactance values or the medium and high reactance values.

Additionally and/or alternatively, the binary search process can include selecting one of the subset of the plurality of reactance values to tune the null steering antenna in the selected mode. For instance, in some embodiments, the binary search process can include selecting a middle reactance value of the subset of the plurality of reactance values. For instance, in some embodiments, the binary search process (e.g., the selecting one of the subset of the plurality of reactance values) can include determining (e.g., by the controller 208) that the sampled channel quality indicator of a sample reactance value of the subset of the span of reactance values satisfies a quality threshold and in response to determining that the sampled channel quality indicator of a sample reactance value of the subset of the span of reactance values satisfies a quality threshold, selecting the sample reactance value to tune the null steering antenna in the selected mode. For instance, the binary search process can be terminated once the sample reactance value is determined to provide a sufficiently good channel quality. Additionally and/or alternatively, the binary search process can be terminated after a predetermined number of iterations.

In some embodiments, after the binary search process has sufficiently reduced a size of the span (e.g., to satisfy a quality threshold, after a certain number of iterations, etc.) the controller 208 can further be configured to search within the reduced span to identify a reactance value providing an optimal (e.g., near maximum) channel quality. In some embodiments, for example, the controller 208 can sample channel quality at reactance values above and/or below the reactance value selected by the binary search process and determine if the sampled values provide a better channel quality than the binary search process selected reactance value. If the controller 208 determines that a sampled value provides a better channel quality than the selected value, the controller can continue to search in the directed of the sampled value. For example, if the controller 208 determines that a sampled value greater than the selected value provides improved channel quality, then the controller 208 can continue to search values greater than the selected value and/or stop searching values less than the selected values.

In some embodiments, for instance, the controller 208 can incrementally adjust the selected reactance value in a first direction at a first step size and sample the channel quality at the selected reactance value until the adjustment in the first direction does not improve the channel quality and/or causes a decrease in channel quality. Once the channel quality is not improved and/or decreases, the controller can adjust the selected reactance value in a second direction at a second step size until the adjustment in the second direction does not improve the channel quality and/or causes a decrease in channel quality, at which point the controller 208 can adjust the selected reactance value in the first direction (e.g., at a third step size). This can be repeated until the selected reactance value converges on an optimal reactance value. In some embodiments, the first step size and the second step size can be identical and/or determined by the channel quality indicator. For example, channel quality and step size can be inversely variable. As another example, the step sizes can decrease with each successive iteration. For instance, the first step size can be greater than the second step size, which can be greater than a third step size in the first direction after the adjustment in the second direction does not improve the channel quality and/or causes a decrease in channel quality.

This incremental adjustment process can achieve improved granularity over a small interval compared to the binary search process (e.g., if the starting selected reactance value is already somewhat close to optimal). However, it can present challenges if employed on a wide span. For instance, the controller may spend an unnecessary amount of time sampling reactance values that are far from an optimal reactance value. Thus, reducing the span by a binary search process and then operating on the reduced span with the incremental adjustment process can overcome these challenges.

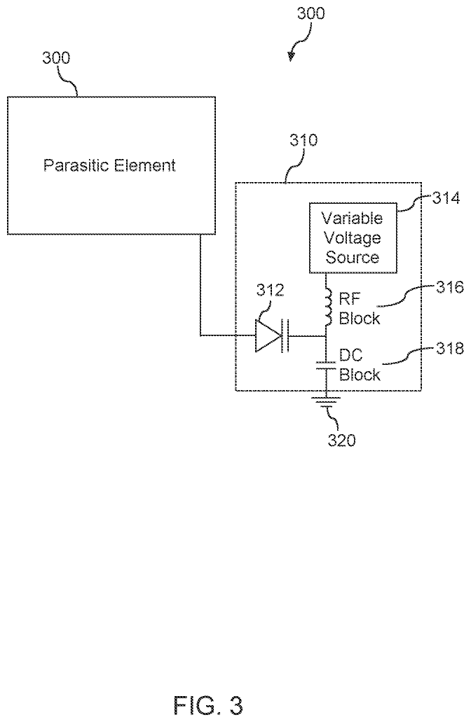

FIG. 3 illustrates a schematic diagram of an example antenna system 300 including a variable active steering element 310 according to example embodiments of the present disclosure. Variable active steering element 310 can vary a reactance to tune parasitic element 302. For instance, parasitic element 302 can be in proximity to a radiating element (e.g., radiating element 202 of FIG. 2) and configured to select an operating mode of a null steering antenna based on the reactance provided by variable active steering element 310.

Variable active steering element 310 can include variable reactance element 312. For instance, in some embodiments, variable reactance element 312 can be a varactor diode. Variable reactance element 312 can be coupled to parasitic element 302 (e.g., by a wire, electrical trace, etc.) such that variable reactance element 312 provides a variable reactance at the parasitic element 302.

Variable active steering element 310 can include variable voltage source 314. Variable voltage source can be coupled to the variable reactance element and configured to vary a voltage at the variable reactance element 312. For instance, the reactance of variable reactance element 312 can be varied based at least in part on the voltage at the variable voltage source 314. As one example, the reactance of the variable reactance element 312 can be a function of the voltage from the variable voltage source 314.

The variable active steering element 310 can further include an RF blocking component 316 coupled to the variable voltage source 314. For instance, the RF blocking component 316 can be coupled between the variable voltage source 314 and the variable reactance element 312. The RF blocking component 316 can be configured to block RF signal components in the variable active steering element 310. As one example, the RF blocking component 316 can be or can include an inductor.

The variable active steering element 310 can further include an DC blocking component 318 coupled to the variable voltage source 314 and/or the variable reactance element 312. For instance, the DC blocking component 318 can be coupled between the variable reactance element 312 and ground 320. The DC blocking component 318 can be configured to block DC signal components in the variable active steering element 310. As one example, the DC blocking component 318 can be or can include a capacitor (e.g., a fixed-capacitance capacitor).

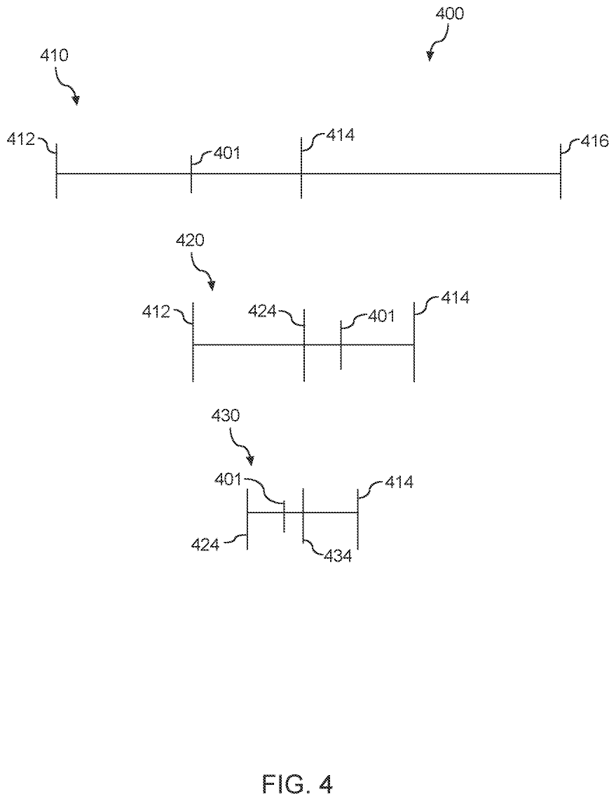

FIG. 4 illustrates an example tuning process 400 according to example embodiments of the present disclosure. In particular, each of charts 410, 420, 430 represents a span of possible reactance values for a variable reactance element, such as any of the variable reactance elements (e.g., active tuning elements) 16, 20, 206, 312 of FIGS. 1-3 and/or any other suitable variable reactance element, at a successive iteration of a binary search process. As illustrated, each of the spans depicted in charts 410, 420, 430 can include an optimal reactance value 401. For instance, a null steering antenna tuned based on optimal reactance value 401 may achieve an optimal (e.g., near maximum) channel quality. Furthermore, values closer to optimal reactance value 401 may generally achieve greater channel quality.

As illustrated in chart 410, the span can include a first extreme reactance value 412 (e.g., a minimum and/or low reactance value), a second extreme reactance value 416 (e.g., a near maximum and/or high reactance value), and a middle reactance value 414 between the first extreme reactance value 412 and the second extreme reactance value 416. The embodiment of FIG. 4 illustrates one middle reactance value 414. In some embodiments, more than one middle reactance value 414 (e.g., evenly spaced between the first extreme reactance value 412 and the second extreme reactance value 416) can be included.

According to example aspects of the present disclosure, a controller (e.g., controller 208 of FIG. 2) can sample channel quality at each of the reactance values 412, 414, 416. As illustrated in FIG. 4, the optimal reactance value 401 lies between the first extreme reactance value 412 and the middle reactance value 414. Thus, the sampled channel quality at reactance values 412 and 414 can be greater than the sampled channel quality at second extreme reactance value 416. The controller can thus determine the subset of the span including the optimal reactance value 401 as being between reactance values 412 and 414, as depicted in chart 420. In the second iteration, the controller can sample second middle reactance value 424 between reactance values 412 and 414. Similarly, the controller can sample the channel quality at each of the reactance values 412, 414, and 424. As illustrated in FIG. 4, the optimal reactance value 401 now lies between reactance values 424 and 414, which will result in the sampled channel quality at reactance values 424 and 414 being higher than the sampled channel quality at first extreme reactance value 412. The controller can thus determine the subset of span including the optimal reactance value 401 as being between reactance values 424 and 414, as depicted at chart 430.

In cases where the chart 430 is representative of a span at termination of the binary search process (e.g., the controller is configured to perform two iterations, the span is sufficiently limited, etc., the controller can select a reactance value from the span depicted in chart 430 to tune a parasitic element. For instance, in some embodiments, the controller can select third middle reactance value 434 as approximating the optimal reactance value 401. Additionally and/or alternatively, the controller can perform an incremental adjustment process (e.g., starting at middle reactance value 434) to incrementally adjust a selected reactance value to more closely approximate and/or determine the optimal reactance value 401.

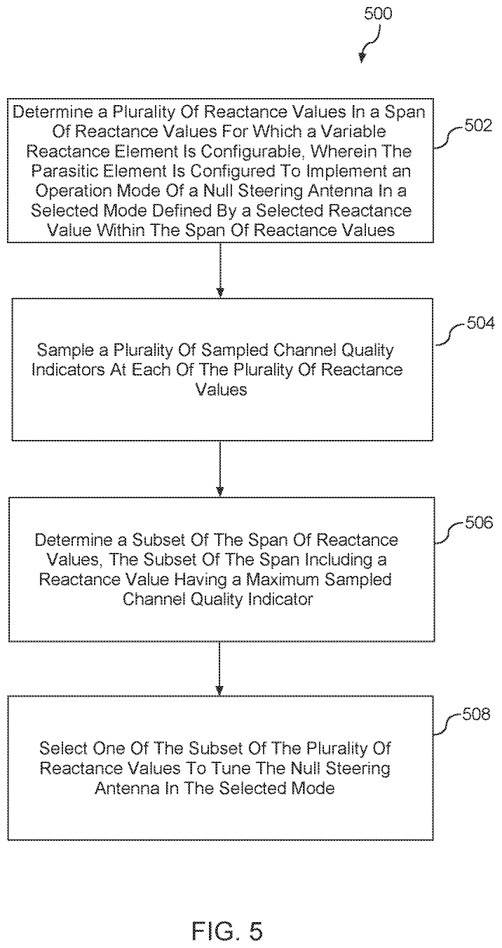

FIG. 5 illustrates a flow diagram of an example method 500 according to example embodiments of the present disclosure. FIG. 5 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 500 is generally discussed with reference to the antenna systems 100, 200, 300 described above with reference to FIGS. 1-3. However, it should be understood that aspects of the present method 500 can find application with any suitable antenna system including a null steering antenna.

According to example aspects of the present disclosure, the method 500 can include, at 502, determining (e.g., by a controller) a plurality of reactance values in a span of reactance values for which a variable reactance element is configurable. For example, the variable reactance element can define a span, such as a continuous span, of reactance values that the variable reactance element is capable of being configured to provide. In some embodiments, for example, the span of reactance values may be dependent on a span of voltage and/or current values that can be provided to and/or across the variable reactance element. As one example, the plurality of reactance values may include a low reactance value, such as a minimum reactance value of the span of reactance values, and a high reactance value, such as a near maximum reactance value of the span of reactance values. Additionally and/or alternatively, the plurality of reactance values can include a medium reactance value between the minimum reactance value and the near maximum reactance value, such as a middle reactance value that is halfway between the minimum reactance value and the near maximum reactance value.

Additionally and/or alternatively, the method 500 can include, at 504, sampling (e.g., by the controller) a plurality of sampled channel quality indicators at each of the plurality of reactance values. For instance, the controller can obtain the sampled channel quality indicators at a selected set of the span of reactance values. As one example, the controller can sample a low reactance value (e.g., a minimum defined by the span of reactance values), a high reactance value (e.g., a near maximum defined by the span of reactance value), and a middle reactance value splitting the low reactance value and the high reactance value.

Additionally and/or alternatively, the method 500 can include, at 506, determining (e.g., by the controller) a subset of the span of reactance values. For instance, the subset of the span can include a reactance value having a near maximum sampled channel quality indicator. As an example, the samples can generally be indicative of a reactance that provides optimal channel quality (e.g., a near maximum channel quality). For example, the samples can bound a reactance value that provides an optimal channel quality. Generally, two of the reactance values having the highest sampled channel quality indicator can bound the optimal channel quality reactance value.

In some embodiments, determining the subset of the span of reactance values can include determining (e.g., by the controller) a first reactance value associated with a highest sampled channel quality indicator and a second reactance value associated with a next highest sampled channel quality indicator. The subset of the span can thus be between the first reactance value and the second reactance value. As one example, if the sampled channel quality indicators correspond to a low reactance value, a medium reactance value, and a high reactance value, the two of the three sampled reactance values with the highest channel quality indicators can bound the optimal reactance value. For instance, one of the two bounding reactance values can have a highest sampled channel quality indicator and the other of the two bounding reactance values can have a next highest sampled channel quality indicator. The next highest sampled channel quality can be equivalent to the highest sampled channel quality indicator, in some cases. Thus, the subset of the span of reactance values can be determined to be between one of the low and medium reactance values or the medium and high reactance values.

Additionally and/or alternatively, the method 500 can include, at 508, selecting one of the subset of the plurality of reactance values to tune the null steering antenna in the selected mode. For instance, in some embodiments, the method 500 can include selecting a middle reactance value of the subset of the plurality of reactance values. For instance, in some embodiments, the method 500 (e.g., the selecting one of the subset of the plurality of reactance values) can include determining (e.g., by the controller) that the sampled channel quality indicator of a sample reactance value of the subset of the span of reactance values satisfies a quality threshold and in response to determining that the sampled channel quality indicator of a sample reactance value of the subset of the span of reactance values satisfies a quality threshold, selecting the sample reactance value to tune the null steering antenna in the selected mode. For instance, the selecting step 508 can be performed once the sample reactance value is determined to provide a sufficiently good channel quality.

In some embodiments, a plurality of iterations of steps 502 through 506 can be performed to reduce a size of the span (e.g., to satisfy a quality threshold, after a certain number of iterations, etc.), after which (e.g., after the one of the subset of the plurality of the reactance values) the controller can further be configured to search within the reduced span to identify a reactance value providing an optimal (e.g., near maximum) channel quality. In some embodiments, for example, the controller can sample channel quality at reactance values above and/or below the reactance value selected by the method 500 and determine if the sampled values provide a better channel quality than the selected reactance value. If the controller determines that a sampled value provides a better channel quality than the selected value, the controller can continue to search in the directed of the sampled value. For example, if the controller determines that a sampled value greater than the selected value provides improved channel quality, then the controller can continue to search values greater than the selected value and/or stop searching values less than the selected values.

In some embodiments, for instance, the controller can incrementally adjust the selected reactance value in a first direction at a first step size and sample the channel quality at the selected reactance value until the adjustment in the first direction does not improve the channel quality and/or causes a decrease in channel quality. Once the channel quality is not improved and/or decreases, the controller can adjust the selected reactance value in a second direction at a second step size until the adjustment in the second direction does not improve the channel quality and/or causes a decrease in channel quality, at which point the controller 208 can adjust the selected reactance value in the first direction (e.g., at a third step size). This can be repeated until the selected reactance value converges on an optimal reactance value. In some embodiments, the first step size and the second step size can be identical and/or determined by the channel quality indicator. For example, channel quality and step size can be inversely variable. As another example, the step sizes can decrease with each successive iteration. For instance, the first step size can be greater than the second step size, which can be greater than a third step size in the first direction after the adjustment in the second direction does not improve the channel quality and/or causes a decrease in channel quality.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna system, comprising:
a null steering antenna comprising a radiating element and a parasitic element, the null steering antenna operable in a selected mode of a plurality of modes, each mode of the plurality of modes associated with a different radiation pattern;
a variable reactance element coupled to the parasitic element, the variable reactance element configured to vary a reactance at the parasitic element to select the selected mode; and
a controller configured to vary the reactance to tune the null steering antenna in the selected mode of the plurality of modes;
wherein the controller is configured to vary the reactance by performing a binary search process to select a reactance based at least in part on a channel quality indicator associated with the null steering antenna in the selected mode.

2. The antenna system of claim 1, wherein performing the binary search process comprises:
determining, by the controller, a plurality of reactance values in a span of reactance values for which the variable reactance element is configurable;
sampling, by the controller, a plurality of sampled channel quality indicators at each of the plurality of reactance values;
determining, by the controller, a subset of the span of reactance values, the subset of the span including a reactance value having a near maximum sampled channel quality indicator; and
selecting one of the subset of the plurality of reactance values to tune the null steering antenna in the selected mode.

3. The antenna system of claim 2, wherein the plurality of reactance values comprises a low reactance value, a medium reactance value, and a high reactance value.

4. The antenna system of claim 2, wherein determining, by the controller, the subset of the span of reactance values comprises determining, by the controller, a first reactance value associated with a highest sampled channel quality indicator and a second reactance value associated with a next highest sampled channel quality indicator, wherein the subset of the span is between the first reactance value and the second reactance value.

5. The antenna system of claim 2, further comprising:
determining, by the controller, that the sampled channel quality indicator of a sample reactance value of the subset of the span of reactance values satisfies a quality threshold; and
in response to determining, by the controller, that the sampled channel quality indicator of the sample reactance value of the subset of the span of reactance values satisfies the quality threshold, selecting the sample reactance value to tune the null steering antenna in the selected mode.

6. The antenna system of claim 1, wherein the variable reactance element comprises a continuously variable reactance element.

7. The antenna system of claim 1, wherein the variable reactance element comprises a varactor diode.

8. The antenna system of claim 1, wherein the antenna system further comprises a variable voltage source coupled to the variable reactance element and configured to vary a voltage at the variable reactance element, and wherein the reactance is varied based at least in part on the variable voltage source.

9. The antenna system of claim 8, further comprising an RF blocking component coupled to the variable voltage source.

10. The antenna system of claim 8, further comprising a DC blocking component coupled to the variable voltage source.

11. A method for tuning an antenna system comprising a parasitic element coupled to a variable reactance element, the method comprising:
determining, by a controller, a plurality of reactance values in a span of reactance values for which a variable reactance element is configurable, wherein the parasitic element is configured to implement an operation mode of a null steering antenna in a selected mode defined by a selected reactance value within the span of reactance values;
sampling, by the controller, a plurality of sampled channel quality indicators at each of the plurality of reactance values;
determining, by the controller, a subset of the span of reactance values, the subset of the span including a reactance value having an increased sampled channel quality indicator; and
selecting one of the subset of the plurality of reactance values to tune the null steering antenna in the selected mode.

12. The method of claim 11, wherein the plurality of reactance values comprises a low reactance value, a medium reactance value, and a high reactance value.

13. The method of claim 11, wherein determining, by the controller, the subset of the span of reactance values comprises determining, by the controller, a first reactance value associated with a highest sampled channel quality indicator and a second reactance value associated with a next highest sampled channel quality indicator, wherein the subset of the span is between the first reactance value and the second reactance value.

14. The method of claim 11, further comprising:
determining, by the controller, that the sampled channel quality indicator of a sample reactance value of the subset of the span of reactance values satisfies a quality threshold; and
selecting the sample reactance value to tune the null steering antenna in the selected mode.

15. The method of claim 14, further comprising:
incrementally sampling the subset of the span of reactance values to identify a near maximum channel quality; and
configuring the variable reactance element such that the near maximum channel quality is achieved.

16. The method of claim 15, wherein incrementally sampling the subset of the span of reactance values comprises iteratively sampling a reactance value above the selected one of the subset of the span of reactance values and a reactance value below the selected one of the subset of the span of reactance values.

17. The method of claim 11, wherein the channel quality indicator comprises received signal strength indicator.

18. An antenna system, comprising:
a null steering antenna comprising a radiating element and a parasitic element, the null steering antenna operable in a plurality of modes, each mode of the plurality of modes associated with a different radiation pattern;
a varactor diode coupled to the parasitic element; and
a controller configured to vary a reactance of the varactor diode to tune the modal antenna to one of the plurality of modes.

19. The antenna system of claim 18, further comprising:
a variable voltage source configured to provide a variable voltage at the varactor diode;
an RF blocking component coupled between the variable voltage source and the varactor diode; and
a DC blocking element coupled between the RF blocking element and ground;
wherein the reactance varies with the variable voltage.

20. The antenna system of claim 18, wherein the controller is configured to vary the reactance of the varactor diode to tune the null steering antenna to one of the plurality of modes to improve a channel quality indicator associated with the null steering antenna.
